(19) United States
(12) Patent Application Publication
(10) Pub. No.: US 2026/0036496 A1
(43) Pub. Date: Feb. 5, 2026

(54) SYSTEMS, DEVICES AND METHODS FOR COLLECTING A SAMPLE OF A GAS IN AN AQUEOUS ENVIRONMENT

(71) Applicant: Saint Mary's University, Halifax (CA)

(72) Inventors: Gregory Todd Ventura, Halifax (CA); Jeremy Bentley, Halifax (CA)

(21) Appl. No.: 18/998,217

(22) PCT Filed: Jul. 26, 2023
(86) PCT No.: PCT/CA2023/051008

§ 371 Date: Jan. 24, 2025

Related U.S. Application Data
(60) Provisional application No. 63/392,224, filed on Jul. 26, 2022.

(51) Int. Cl. G01N 1/22

(52) U.S. Cl. CPC G01N 1/2202; G01N 2001/2291

(57) ABSTRACT

A system for collecting a sample of a gas in an aqueous environment is described herein. The system includes a collection vessel having a body having a cavity and a bottom edge forming a perimeter around an opening on an underside of the body. The opening is sized to receive the sample of the gas into the cavity as the sample of the gas travels upwardly and the main body is positioned directly above the sample of gas in the aqueous environment. The collection vessel also includes a valve coupled to the body. The valve provides for the sample of the gas to be removed from the cavity without travelling through the opening on the underside of the main body. The collection vessel also includes a confinement structure having a and a coupling mechanism configured to retain the collection vessel at least partially in the confinement structure.

### TECHNICAL FIELD

The embodiments disclosed herein relate to systems, devices and methods for collecting a sample of gas, and more specifically, to systems, devices and methods for collecting a sample of a gas in an aqueous environment.

### BACKGROUND

The following paragraphs are not an admission that anything discussed in them is prior art or part of the knowledge of persons skilled in the art.

Oil and gas seeps are common worldwide and typically occur both on land and in aqueous environments, such as beneath the ocean or beneath other bodies of water. Oil seeps may be biogenic, thermogenic, or mixed in origin. Biogenic gas seeps have a microbial metabolic origin. Thermogenic gas seeps occur when hydrocarbons rise to a surface from more deeply buried source rock horizons or accumulations.

Oil seeps in aqueous environments can be used to identify potential active petroleum sites for extraction. Traditionally, oil seeps in subsea environments (e.g. seeps from an ocean floor) have been detected using subsurface geologic surveys Unfortunately, these can be very expensive to conduct. Other ways to detect oil seeps in subsea environments have included investigating surface topographic features of the subsea environment, such as organisms living in area where an oil seep is suspected to be present.

Once a potential oil seep site is identified, it is commonly investigated and imaged in more detail. This may include deploying a multibeam or side-scan sonar to detect gas flares or having one or more individuals travel to the potential seep site in a submersible, or by sending a remote operated vehicle (ROV). If gas is seen to be bubbling up from the identified site, it can be advantageous to collect a sample of the gas to test the sample and determine its molecular and isotopic composition.

Natural seepage is one mode of natural gas exploration. However, due to extensive offshore drilling of oil and gas and the pipelines that connect petroleum producing fields, environmental impact surveys and remediation efforts are needed. In this regard, gas sampling of leaking drill sites, abandoned well and active and abandoned pipelines produces point-sourced pollution. To determine if the leaking gas is due to faulty equipment, geochemical analysis and fingerprinting is required. This demands the on-site collection of the leaking gas.

Current systems for collecting a sample of a gas seeping from an aqueous environment, such as a seabed or from active and abandoned petroleum production equipment in a subsea environment, include, for example, isobaric gas samplers that maintain the sample of the gas at a pressure equal or near to the pressure of the aqueous environment where it was collected. However, gas-pressure expansion kinetics does not impact the fundamental geochemical composition of the sample. Further, use of previous systems that maintain the sample of the gas at a pressure equal or near to the pressure of the aqueous environment has an explosion risk.

Therefore, the use of bellows to bring a sample of a gas collected in an aqueous environment has increased recently. However, to accurately investigate the geochemical composition of the sample, it remains important to not mix the sample of the gas collected with atmospheric air.

Accordingly, in view of the above, there is a need to develop new systems, devices and methods for collecting a sample of a gas in an aqueous environment.

### SUMMARY

In accordance with a broad aspect, a system for collecting a sample of a gas in an aqueous environment is described herein. The system includes a collection vessel having a body having an outer wall defining a cavity of the main body; a bottom edge forming a perimeter around an opening on an underside of the body, the cavity extending inwardly from the opening, the opening being sized to receive the sample of the gas into the cavity as the sample of the gas travels upwardly and the main body is positioned directly above the sample of gas in the aqueous environment; and a valve coupled to the body, the valve being configured to provide for the sample of the gas to be removed from the cavity without the sample of the gas travelling through the opening on the underside of the main body. The collection vessel also includes a confinement structure comprising: a frame having at least one side wall, an opening on a top side of the frame and a cavity extending inwardly from the opening, the opening being sized to receive the collection vessel therein after the collection vessel has collected the sample of the gas; and a coupling mechanism configured to retain the collection vessel at least partially in the confinement structure, the opening of collection vessel remaining below the opening of the confinement structure when the collection vessel is received in the cavity of the confinement structure to retain the collection vessel in the confinement structure and provide for the sample of the gas to remain inside the cavity of the collection vessel.

In at least one embodiment, the collection vessel includes a first handle coupled to the main body and extending upwardly from the main body.

In at least one embodiment, the lid is further configured to provide for the first handle to extend outwardly from the confinement structure when the collection vessel is retained in the cavity of the confinement structure.

In at least one embodiment, the lid is shaped to define an opening therein to provide for the first handle to extend outwardly from the confinement structure when the collection vessel is retained in the cavity of the confinement structure.

In at least one embodiment, the lid is shaped to define an opening therein to provide for the valve to extend outwardly from the confinement structure when the collection vessel is retained in the cavity of the confinement structure.

In at least one embodiment, the lid is configured to move between a first position where it does not obstruct the opening of the confinement structure and a second position where it at least partially obstructs the opening of the confinement structure.

In at least one embodiment, the lid is configured to slide between the first position and the second position along an upper edge of the frame of the confinement structure.

In at least one embodiment, a height of the confinement structure is greater than a height of the body of the collection vessel.

In at least one embodiment, the collection vessel includes one or more vents in a lower portion thereof to provide for excess gas and water within the cavity of the collection vessel to move outwardly from the collection vessel through the vents and into the cavity of the confinement structure when collection vessel is positioned within the cavity of the confinement structure.

In at least one embodiment, a height of an uppermost portion of the one or more vents is less than a height of the sidewalls of the confinement structure.

In at least one embodiment, the collection vessel includes a second handle extending laterally outward from the body.

In at least one embodiment, the body has an upper component and a lower component, the lower component having a first portion coupled to a second portion, each of the upper component, the first portion of the lower component and the second portion of the lower component having respective cavities that are fluidly coupled to each other, the second portion having the bottom edge forming the perimeter around the opening.

In at least one embodiment, the first portion of the lower component is shaped to restrict movement of the sample of gas from the cavity of the upper component towards the opening.

In at least one embodiment, the first portion of the lower component has a truncated biconical shape.

In at least one embodiment, the second portion of the lower component has a conical shape.

In at least one embodiment, the body is configured to separately collect and separately retain more than one sample of the gas and/or more than one sample of more than one gas.

In accordance with another broad aspect, a method of collecting a sample of a gas from an aqueous environment is described herein. The method includes: positioning an opening of a collection vessel above the sample of the gas within the aqueous environment; providing for the sample of gas to pass upwardly through the opening and into a cavity of the collection vessel; placing the collection vessel inside a cavity of a confinement structure in an upright position, the cavity of the confinement structure having water retained therein; securing the collection vessel at least partially within the cavity of the confinement structure; and collecting the sample of the gas from the cavity of the collection vessel through a valve of the collection vessel.

In at least one embodiment, placing the collection vessel inside the cavity of a confinement structure in an upright position includes passing the collection vessel through the opening of the confinement structure while the collection vessel is in the upright position.

In at least one embodiment, securing the collection vessel at least partially within the cavity of the confinement structure inhibits the collection vessel from moving between the upright position and an inverted position, thereby retaining the sample of the gas in the cavity of the collection vessel below a water seal.

In at least one embodiment, securing the collection vessel at least partially within the cavity of the confinement structure provides for a user to grasp a handle of the collection vessel and control movement of the collection vessel and the confinement structure.

### BRIEF DESCRIPTION OF THE DRAWINGS

The drawings included herewith are for illustrating various examples of articles, methods, and apparatuses of the present specification. In the drawings:

FIG. 1 is a front perspective view of a system for collecting a sample of a gas from an aqueous environment, according to at least one embodiment described herein.

FIG. 2 is a front perspective view of a collection vessel of a system for collecting a sample of a gas from an aqueous environment, according to at least one embodiment described herein.

FIG. 3 is a front perspective view of another collection vessel of a system for collecting a sample of a gas from an aqueous environment, according to at least one embodiment described herein.

FIG. 4A is a top view of the collection vessel of FIG. 2.

FIG. 4B is a bottom view of the collection vessel of FIG. 2.

FIG. 5 is a front perspective view of a confinement structure of a system for collecting a sample of a gas from an aqueous environment, according to at least one embodiment described herein.

FIG. 6A is a side view of a remote operated vehicle (ROV) using a system according to at least one embodiment described herein, to collect a sample of a gas from an aqueous environment.

FIG. 6B is a magnified side view of a top portion of a collection vessel of the system shown in FIG. 6A showing the sample of the gas collected within the collection vessel.

FIG. 7A is a front perspective view of two confinement structures according to at least one embodiment described herein coupled together.

FIG. 7B is a top view of four confinement structures according to at least one embodiment described herein coupled together in a first configuration, showing each of their lids in a first position.

FIG. 7C is a front perspective view of four confinement structures according to at least one embodiment described herein coupled together.

FIG. 7D is a top view of four confinement structures according to at least one embodiment described herein coupled together in a second configuration, showing each of their lids in a first position.

FIGS. 8A-8F show steps in a method of collecting a sample of a gas from an aqueous environment, according to at least one embodiment described herein.

FIG. 9A is a front perspective view of another system for collecting a sample of a gas from an aqueous environment, according to at least one embodiment described herein.

FIG. 9B is a front perspective view of another system for collecting a sample of a gas from an aqueous environment, according to at least one embodiment described herein.

FIG. 10 is a front perspective view of a collection vessel of the system of FIG. 9A.

FIG. 11A is a side view of the collection vessel of FIG. 10.

FIG. 11B is a cross-sectional view of the collection vessel of FIG. 10 along the line A-A of FIG. 11A.

FIG. 12 is a perspective view of FIG. 9B with the first portion shown in dashed lines to show inner features of the second portion.

FIGS. 13A-13D show steps in a method of collecting a sample of a gas from an aqueous environment, according to at least one embodiment described herein.

### DETAILED DESCRIPTION

Various compositions and methods will be described below to provide an example of one or more embodiments. No embodiment described below limits any claimed embodiment and any claimed embodiment may cover compositions or methods that differ from those described below. The claimed embodiments are not limited to compositions and methods having all of the features of any one composition or method described below or to features common to multiple or all of the compositions and methods described below. It is possible that a composition or method described below is not an embodiment of any claimed embodiment. Any embodiment disclosed below that is not claimed in this document may be the subject matter of another protective instrument, for example, a continuing patent application, and the applicants, inventors or owners do not intend to abandon, disclaim or dedicate to the public any such embodiment by its disclosure in this document.

In general, the present document is directed to systems, devices and methods for collecting a sample of a gas seeping within an aqueous environment.

In at least some embodiments described herein, the systems, devices and methods described for collecting the sample of the gas are suitable for use in a deep-sea environment (e.g. the systems, devices and methods are not limited to collecting a sample of a gas at a specific depth). Typically, similar systems, devices and methods current in use are intended to maintain a seabed pressure and prevent the sample of the gas from leaking or expanding when brought to the atmosphere.

In at least some embodiments described herein, the systems, devices and methods described for collecting the sample of the gas are suitable for use in collecting gas samples from offshore abandoned wells, drilling rigs, and/or pipelines to, for example, assess point source pollution sources.

The problems to be solved by the present disclosure are not limited to the above-mentioned problem(s), and other problem(s) not mentioned can be clearly understood by those skilled in the art from the following description.

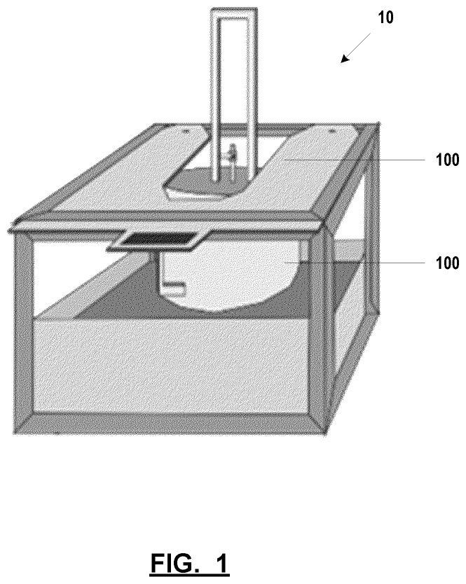

Turning to FIG. 1, illustrated therein is a system 10 for collecting a sample of a gas from an aqueous environment, according to at least one embodiment described herein. System 10 includes a collection vessel 100 and a confinement structure 200. Collection vessel 100 is used to collect the sample of the gas in the aqueous environment, such as but not limited to a lake, ocean or other body of water. In at least one embodiment, the aqueous environment is a deep-sea environment (i.e. the lowest layer in the ocean, existing below the thermocline and above the seabed, at a depth of about 1,800 meters or more) and the sample of the gas seeps upwardly from the seabed. Confinement structure 200 is used to carry the collection vessel 100 out of the body of water while the sample of the gas is retained in the collection vessel 100.

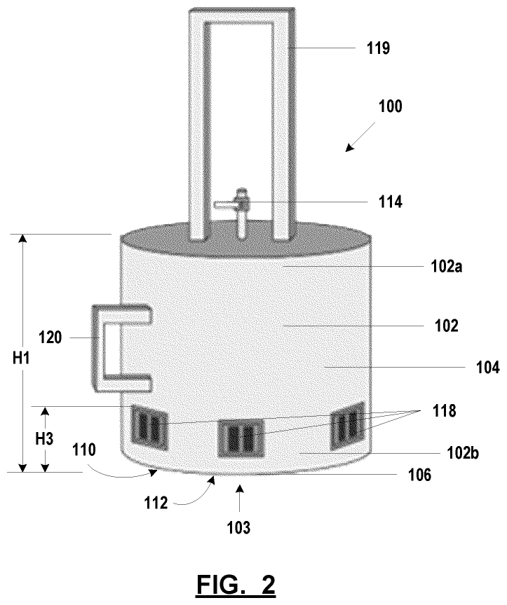

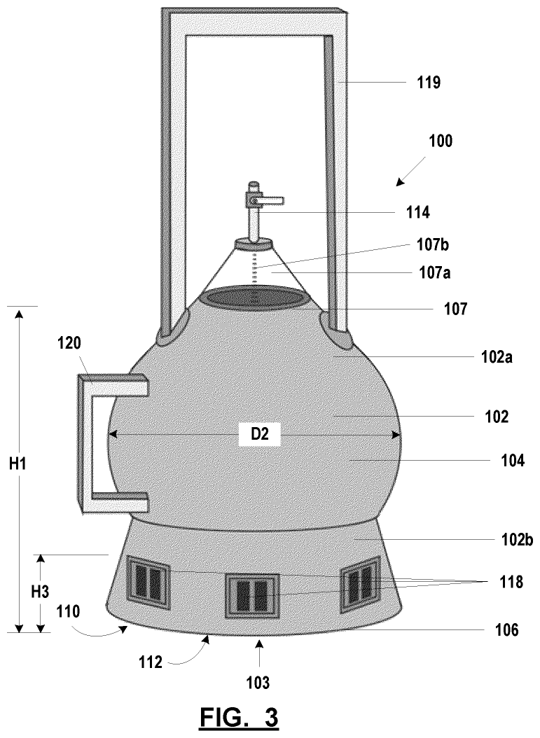

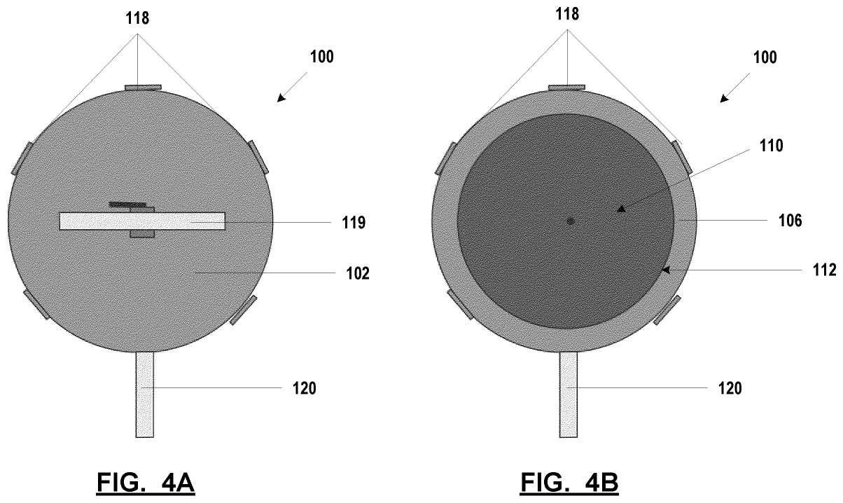

FIGS. 2 and 3 each show an embodiment of collection vessel 100 of system 10. Collection vessel 100 has a body 102 having an upper portion 102a and a lower portion 102b. Body 102 includes an outer wall 104 that defines a cavity 110 therein. Cavity 110 is sized to receive and retain the sample of the gas, for example shortly after the sample of the gas seeps upwardly from a seabed into the water. Cavity 110 is shown in FIG. 4B.

Body 102 has a bottom edge 106 that forms a perimeter around and defines an opening 112 that leads into cavity 110 on an underside 103 of main body 102. Opening 112 is shown in FIG. 4A. Opening 112 is sized to provide for the sample of the gas to be collected by the system 10 by entering into cavity 110, for example as the sample of the gas travels upwardly from the seabed into the water and toward an atmosphere, or for example as the sample of the gas travels upwardly through the water and toward the atmosphere.

Outer wall 104 of collection vessel 100 may be made of any material of sufficient durability to withstand increased pressures present in a deep-sea environment, such as but not limited to stainless steel.

In the embodiment of collection vessel 100 shown in FIG. 1, outer wall 104 of body 102, as well as cavity 110 therein, generally has a cylindrical shape. Those skilled in the art will understand that the embodiment of collection vessel 100 shown in FIG. 1 should not limit the shape of body 102. Body 102 may be any shape that provides a cavity to collect a sample of a gas. For example, FIG. 2 shows another embodiment of collection vessel 100 wherein body 102 has a generally hourglass shape. Therein, body 102 has an upper portion 102a and a lower portion 102b that are joined along a joint 105 extending around body 102.

To provide the body 102 of the embodiment shown in FIG. 2 with an hourglass shape, a width (or diameter) of lower portion 102b decreases from bottom edge 106 of body 102 upwardly towards upper portion 102a. A diameter of upper portion 102a initially increases in a direction upwardly from joint 105 to a widest point D2. The diameter of upper portion 102a then decreases (e.g. at a constant rate) upwardly from widest point D2 towards tip 107 of body 102.

Body 102, and more specifically cavity 110 therein, is sized to provide for the sample of the gas collected from the aqueous environment to increase in volume as the sample of gas is carried upwardly towards an atmosphere. Deep sea environments are at a higher pressure than atmosphere. For example, the pressure increases about one atmosphere for every 10 meters of water depth. Accordingly, a sample of a gas collected within cavity 110 from a deep-sea environment will expand in volume as it is brought upwardly towards the atmosphere. Cavity 110 of body 102 is sized to provide for the sample of the gas to expand therein and remain within the cavity 110.

Body 102 also includes a fitted valve 114 positioned at upper portion 102a (e.g. tip 107). Valve 114 is connectable to a hose, or any other detachable gas line, to remove the gas sample from the cavity 110 of body 102 once the collection vessel 100 has been brought to the surface.

In the embodiment of collection vessel 100 shown in FIG. 3, the tip 107 is shown as being at least partially transparent. This provides for a user of the system 10 to visualize the sample of the gas after it has been collected in the collection vessel 100.

In each of the embodiments shown in the drawings, lower portion 102b of body 102 includes one or more vents 118 in a bottom portion thereof. As the collection vessel 100 is inserted into confinement structure 200 (described in greater detail below) within the aqueous environment, collection vessel 100 and confinement structure 200 will each contain water. As noted above, a sample of a gas collected within cavity 110 from a deep sea environment will expand in volume as it is brought upwardly towards the atmosphere. Vents 118 provide for water retained in cavity 110 with the sample of the gas to be displaced into confinement structure 200 as the collection vessel is brought towards the atmosphere and the sample of the gas expands within cavity 110.

In at least one embodiment, body 102 may be configured to support lead weights that may be used to ensure collection vessel 100 keeps negative buoyancy within the aqueous environment and/or to provide for collection vessel 100 to remain stationary when positioned on a seabed to collect the sample of the gas.

In each of the embodiments of collection vessel 100 shown in the drawings, body 102 includes a first handle 119. First handle 119 extends upwardly from body 102 (e.g. top portion 102a of body 102) and provides for a point of attachment for a person and/or a remote-operated vehicle (ROV) that is collecting the sample of gas to grab the collection vessel 100. First handle 119 may extend from any portion of body 102, such as but not limited to from a top surface 121 of body 102 as shown in the embodiment shown in FIG. 2, or from upper portion 102a as shown in the embodiment shown in FIG. 3.

Body 102 may optionally also include a second handle 120. In each of the embodiments of collection vessel 100 shown in the drawings, second handle 120 may extend outwardly from body 102 in a direction transverse to a direction that first handle 119 extends from body 102. Second handle 120 may provide another point of attachment for a person and/or a ROV that is collecting the sample of gas to grab the collection vessel 100. In at least one embodiment, first handle 119 is longer than second handle 120 to provide for the ROV or a person to more easily access first handle 119 when collecting the sample of the gas, particularly in setting where the seabed may be irregular. Similarly, the second handle 120 may be shorter than the first handle 119 to provide for not obstruct the collection vessel 100 as it is positioned within confinement structure 200, as further described below.

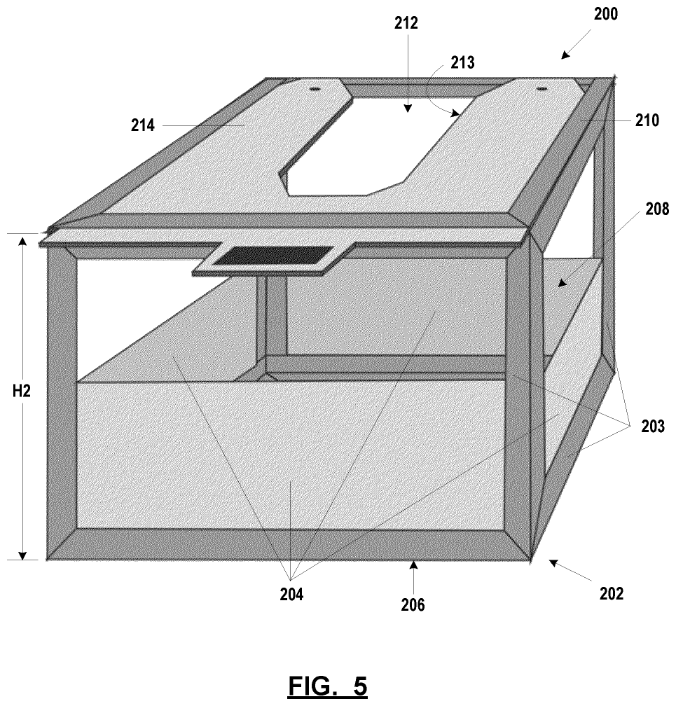

Turning to FIG. 5, illustrated therein is a confinement structure 200 according to at least one embodiment described herein. Confinement structure 200 includes a frame 202 defined by a plurality of frame members 203. Frame 202 includes one or more outer walls 204 and a lower wall 206 extending between the frame members 203, the one or more outer walls 204, lower wall 206 and frame members 203 co-operating to define a cavity 208 therein. Each of the one or more outer walls 204 and the lower wall 206 are solid structures to provide for retaining water within cavity 208. In the embodiments shown in the drawings, uppermost edges 210 of outer walls 204 define an opening 212 that is sized and shaped for the collection vessel 100 to pass therethrough and be positioned within the cavity 208 of confinement structure 200.

Confinement structure 200 also includes a lid 214 configured to at least partially close opening 213 to provide for retaining collection vessel 100 in cavity 208 as system 10 is brought from an aqueous environment towards the surface. Lid 214 is configured to retain collection vessel 100 in an upright position when the collection vessel 100 is held in the confinement structure 200 while the system 10 is brought towards the surface to ensure that the sample of the gas is retained within the collection vessel 100. Accordingly, the one or more outer walls 204 of the confinement structure 200 have a height H2 that is greater than a height H1 of the body 102 of collection vessel 100. When collection vessel 100 is placed within cavity 208 of confinement structure 200 and lid 214 is moved from a first position where it does not obstruct the opening 212 to a second position where it at least partially closes the opening 212, an underside 213 of lid 214 either abuts or is sufficiently close to tip 107 of collection vessel 100 that lid 214 inhibits collection vessel 100 from rotating within the collection vessel. If the collection vessel 100 were able to rotate or move within the confinement structure 200 to an inverted position (i.e. a position where the opening 112 of the collection vessel 100 is vertically higher (e.g. is closer to the surface of the aqueous environment) than the tip 107), the sample of the gas, being less dense than water, would be able to pass upwardly through the opening 112 of the collection vessel 100 and be lost.

Lid 214 is configured to move between a first position and a second position. In the first position, the lid 214 at least partially obstructs opening 212 of the confinement structure 200. In its second position, the lid 214 retains the collection vessel 100 in the cavity 208 of the confinement structure 200. In its second position, the lid 214 also inhibits the collection vessel 100 in the cavity 208 of the confinement structure 200 from moving between its upright position and the inverted position.

Lid 214 is also configured to provide for first handle 119 and/or valve 114 to extend outwardly from the confinement structure 200. Lid 214 is shaped to define an opening 220 that is configured to provide for first handle 119 and/or valve 114 to extend outwardly from the confinement structure 200 while also maintaining the collection vessel 100 in its upright position while the collection vessel 100 is retained in the confinement structure 200.

It should also be noted that confinement structure 200 is configured to retain a volume of water within cavity 208 of the confinement structure 200 that inhibits an ingress of air from the atmosphere into the cavity 110 of the collection vessel 100 when the system 10 is brought out of the aqueous environment. To an ingress of air from the atmosphere into the cavity 110, in the embodiments shown in the drawings, outer walls 204 have a height H2 that is greater than a distance H3 between bottom edge 106 of collection vessel 100 and an uppermost portion of the vents 118. By having a level of water within the cavity 208 of confinement structure 200 that is higher than the uppermost portion of the vents 118, water within cavity 110 of body 102 will remain therein after the system 10 is removed from the aqueous environment and the sample of the gas will remain trapped in an upper portion of the cavity 110.

In at least one embodiment, confinement structure 200 may include a drainage port (e.g., a thumb screw) at a bottom portion thereof to drain water from the confinement structure 200 after the sample of gas has been collected.

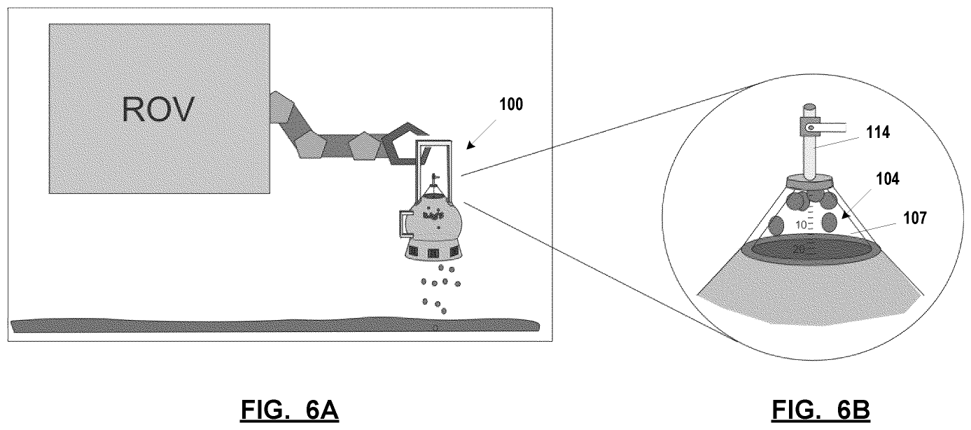

FIGS. 6A and 6B show one embodiment of collection vessel 100 where the sample of gas trapped within an upper portion of cavity 110 is visible through a clear portion of outer wall 104 at tip 107. The clear portion 107a of tip 107 may be regarded as a calibrated funnel having volumetric markings 107b that provide measurement of a volume of gas collected by the vessel 100. The measured volume can be used to calculate a gas seepage rate, for example. Clear portion 107a also provides for a submersible operator to see that a sample of gas has been collected.

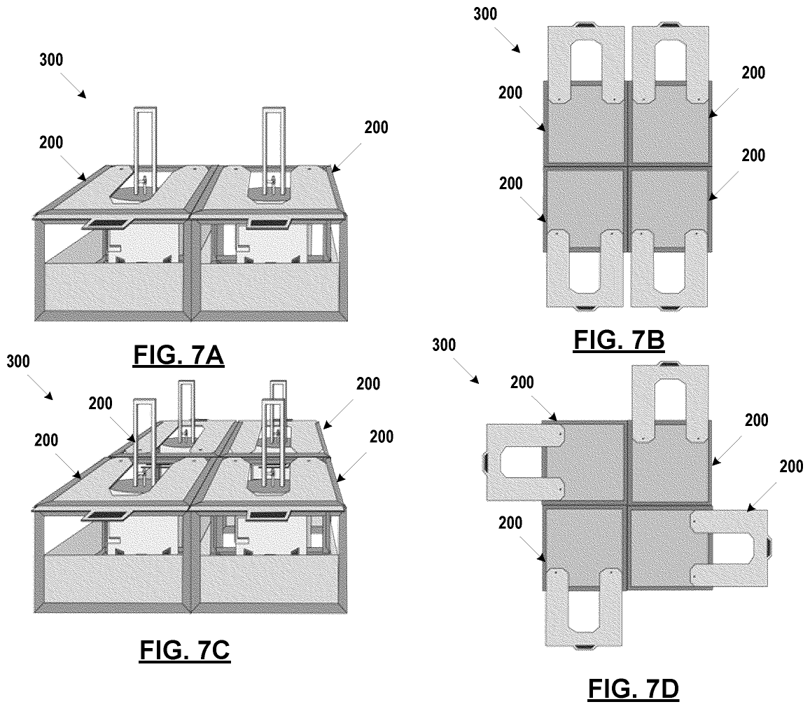

Confinement structure 200 may be configured to couple to one or more other confinement structures 200 to provide a multi-gas sampler system 300 for the simultaneous collection of multiple gas samples. FIGS. 7A to 7D show examples of multi-gas sampler systems 300 and how two or more confinement structures 200 may be coupled together. In at least one embodiment, the confinement structures 200 can be bolted together to provide a multi-gas sampler system 300. In at least one embodiment, the confinement structures 200 can be welded together to provide a multi-gas sampler system 300.

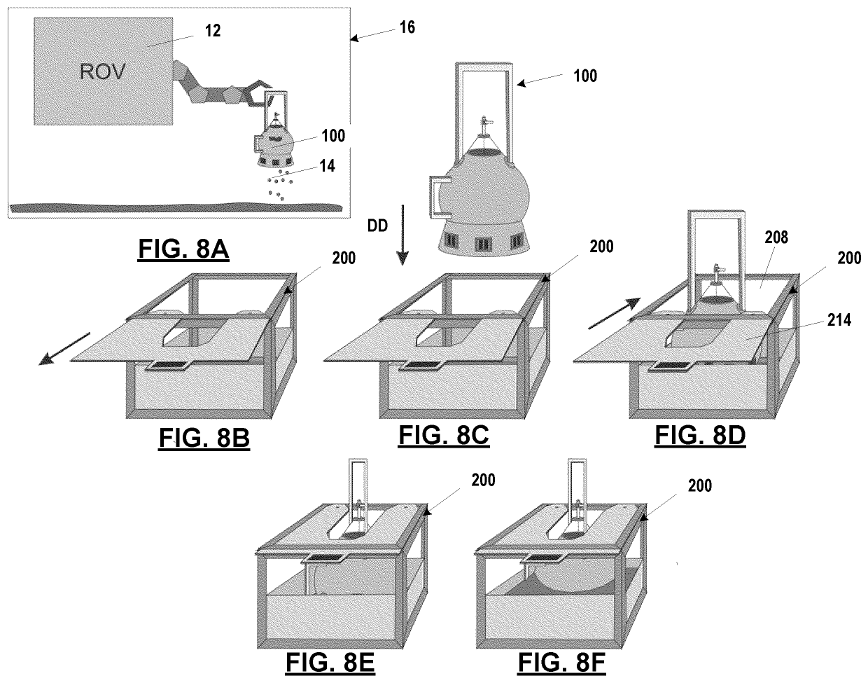

FIGS. 8A to 8F show perspective views of various steps for collection a sample of a gas in an aqueous environment using a system 10 including a collection vessel 100 and a confinement structure 200 according to at least one of the embodiments described herein.

In FIG. 8A, an ROV 12 is shown positioning a collection vessel 100 above a sample of a gas 14 to be collected in an aqueous environment 16. Although an ROV is shown handling the collection vessel 100, it should be understood that other autonomous devices or, alternatively, a user, could position the collection vessel.

After positioning the collection vessel 100 above the sample of the gas 14 to be collected, the collection vessel is held at the position to provide for the sample of the gas 14 to pass through an opening 112 in a bottom of collection vessel 100 and into a cavity 110 of collection vessel 100.

Once the sample of the gas 14 is collected in cavity 110, the collection vessel is placed into a confinement structure 200. FIG. 8B shows one embodiment of a confinement structure 200 having a lid 214 in an open configuration, ready to accept a collection vessel 100 therein.

FIG. 8C shows a collection vessel 100 being lowered in a direction DD downwardly through an opening 212 and into a cavity 208 of confinement structure 200 in an open configuration where lid 214 is at a first position. FIG. 8D shows collection vessel 100 being positioned within cavity 208 of confinement structure 200.

FIG. 8E shows lid 214 having moved from a first position where it does not obstruct opening 212 to a second position where it at least partially obstructs opening 212.

FIG. 8F shows the confinement structure 200 having a level of water therein to inhibit an ingress of air from the atmosphere into cavity 110 of collection vessel 100.

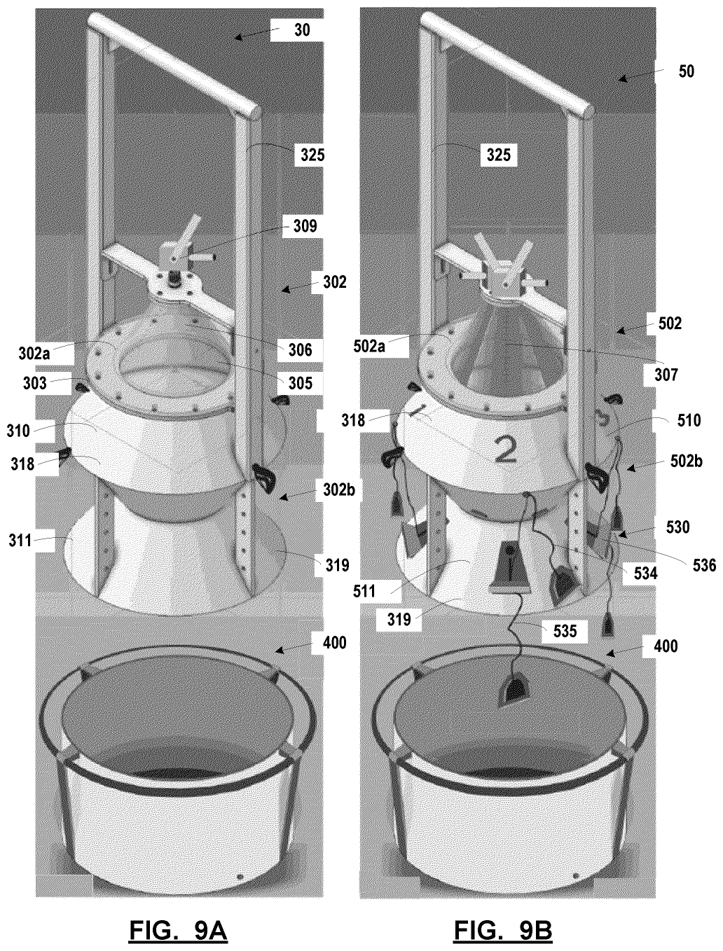

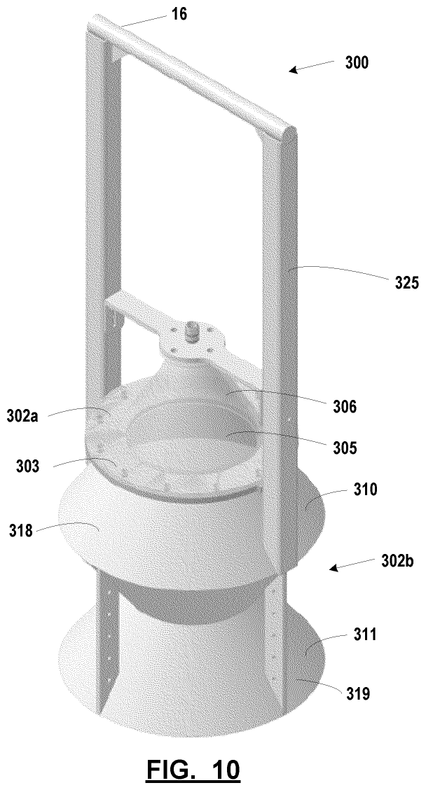

Turning to FIGS. 9A and 9B, illustrated therein are systems 30 and 50, respectively, for collecting a sample of a gas from an aqueous environment. System 30 shown in FIG. 9A includes a single cavity collection vessel 300 and a confinement structure 400. Single cavity collection vessel 300 is further shown in FIG. 10.

Collection vessel 300 has a body 302 having an upper component 302a and a lower component 302b. Upper component 302a is at least partially transparent to provide for a person to visualize a sample of gas that has been collected using collection vessel 300.

Upper component 302a is couped to lower component 302b at a lowermost edge 303. In the embodiment shown in the drawings, lowermost edge 303 is a flange that couples to an upper flange of lower component 302b. Upper component 302a includes an opening 304 that leads into a cavity 305 defined by an outer wall 306 of upper portion 302a. Outer wall 306 is at least partially transparent for a person to visualize a sample of gas received in cavity 305. In some embodiments, outer wall 306 may include a scale or a plurality of markings 307 that can be used by a person to easily quantify a volume of the sample of gas received and retained in cavity 305. In the embodiment shown in the drawings, outer wall 306 has a conical shape. The conical shape provides for the sample of gas to collect at a predetermined point within cavity 305. For example, the sample of gas may collect adjacent to a valve 309 positioned at an apex 308 of the outer wall 306. Valve 309 is connectable to a hose, or any other detachable gas line, to remove the gas sample from the cavity 305 of upper portion 302a once the collection vessel 300 has been brought to the surface. It should be understood that outer wall 306 may have any other shape that provides a cavity 305 therein to receive a sample of gas.

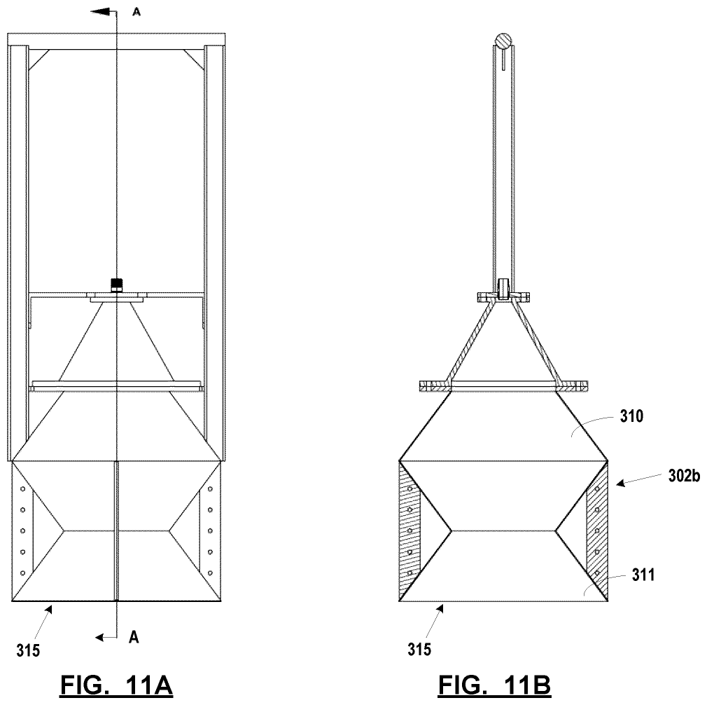

Lower component 302b of body 302 comprises a first portion 310 and a second portion 311. In the embodiment shown in FIG. 9A, first portion 310 has a shape of a truncated bicone (i.e. as if two cones were placed base to base, where each of an upper tip and a lower tip of the bicone has been cut-off, for example straight cut-off). The shape of first portion 310, which may be a bicone as shown herein or may be any other shape that restricts movement of the sample of the gas within the cavity of the first portion 310 and towards an opening of the first portion) provides for a sample of gas collected within cavity 305 therein to remain within the cavity 305 even when the collection vessel 300 is not in an upright position (e.g. a sample of gas collected within a cavity therein when the collection vessel is sideways). For clarity, second portion 311 includes an opening 313 (not shown) that leads to a cavity 314 of second portion 311 and first portion 310 includes an opening 315 (see FIGS. 11A and 11B) that leads to a cavity 316 of first portion 310. Cavities 314, 316 and 305 are fluidly coupled to each other such that a sample of gas collected by the collection vessel 300 passes from cavity 314 to cavity 316 and from cavity 316 to cavity 305 and is retained within cavity 305.

Outer wall 318 of first portion 310 and outer wall 319 of second portion 311 may be made of any material of sufficient durability to withstand increased pressures present in a deep-sea environment, such as but not limited to stainless steel.

In each of the embodiments of collection vessels 300 and 500 shown in the drawings, body 302 and body 502, respectively, includes a handle 325. Handle 325 is coupled to at least a portion of body 302 and extends upwardly therefrom. Handle 325, for example, may be coupled to an outermost portion of outer wall and provide a point of attachment for a person and/or a remote-operated vehicle (ROV) that is collecting the sample of gas to grab the collection vessel 300. First handle 325 may extend from any portion of body 302, such as but not limited to outer wall 318 and/or outer wall 319.

Returning to FIG. 9B, illustrated therein is a system 50 for collecting a sample of a gas from an aqueous environment that includes a multi-cavity collection vessel 500 and a confinement structure 400.

Multi-cavity collection vessel 500 is similar in structure to collection vessel 300 with the exception that collection vessel 500 is configured to collect and separately hold more than one sample of gas therein. To achieve this, collection vessel 500 includes more than one cavity 505 within each of the upper component 502a and/or lower component 502b.

Collection vessel 500 has a body 502 having an upper component 502a and a lower component 502b. Lower component 502b includes a first portion 510 and a second portion 511.

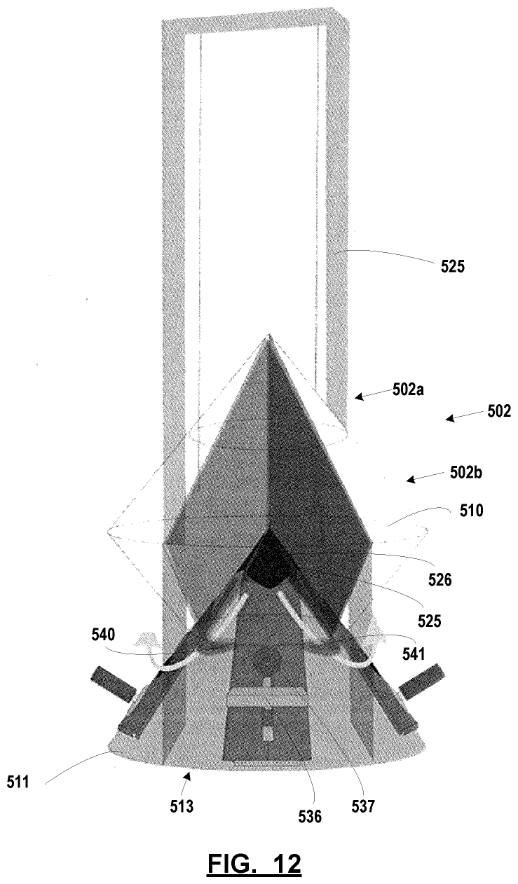

First portion 510 and second portion 511 are configured to provide for multiple samples of gas to be collected and separately retained therein. For instance, in the embodiment shown in FIG. 9B, second portion 511 has a conical shape with more than one opening 525 positioned at an apex 526 thereof. This is shown in FIG. 12. It should be understood that in collection vessel 300, second portion 310 has a similar shape to second portion 510 with a single opening at an apex thereof.

Second portion 511 is configured to provide for more than one sample of gas to be collected in the body 502 without the samples mixing with each other or being contaminated. For example, second portion 511 may include a gate 530 for each compartment of the lower component 502b. Each gate 530 is configured to have an open position, where a sample of gas may pass from a common cavity 513 of the lower component 502b to a cavity of the upper component 502a. In the embodiments shown in the drawings, upper component 502a has four individual cavities for receiving and retaining four individual samples of gas. Each gate 530 may be movable between its open and closed position. For example, in the embodiment shown in the drawings, each gate 530 includes a first draw cord 534 and a second draw cord 535. First draw cord 534 may be used to move a cover 536 of from its open position where it does not cover opening 537 (see FIG. 12) to its closed position where it does cover opening 537. Alternatively, second draw cord 535 may be used to move cover 536 of from its closed position where it does cover opening 537 to its open position where it does not cover opening 537. It should be understood that using the components outlined above, second portion 511 and/or first portion 510 and/or upper component 502a may be configured to provide for two, or three, or four, or five, or six, or seven, or eight, or more than eight samples to be separately collected and separately retained within vessel 500.

In at least one embodiment, first portion 510 and/or second portion 511 may include one or more gas over pressure vents 540 (see FIG. 12). In FIG. 12, a plurality of arrows therein shows that, in the case of gas over pressure, excess gas may escape first portion 510 at a lower edge 541 through the one or more gas over pressure vents 540.

As noted above, both of systems 30 and 50 include a confinement structure 400. Confinement structure 400 includes a body 402 having an outer wall 404 and a bottom wall 406. In the examples shown in FIGS. 9-13, bottom wall 406 is circular and outer wall 404 extends upwardly from a perimeter edge 405 of bottom wall 406, however, it should be understood that the shape of confinement structure 400 should not be limited to being circular.

Confinement structure 400 is configured to be coupled to collection vessel 300 (or 500) in at least two ways: i) as the system 30 (or 50) is descending downwardly into a subsea environment; and ii) after the system 30 (or 50) has collected a sample of gas and is exiting the subsea environment.

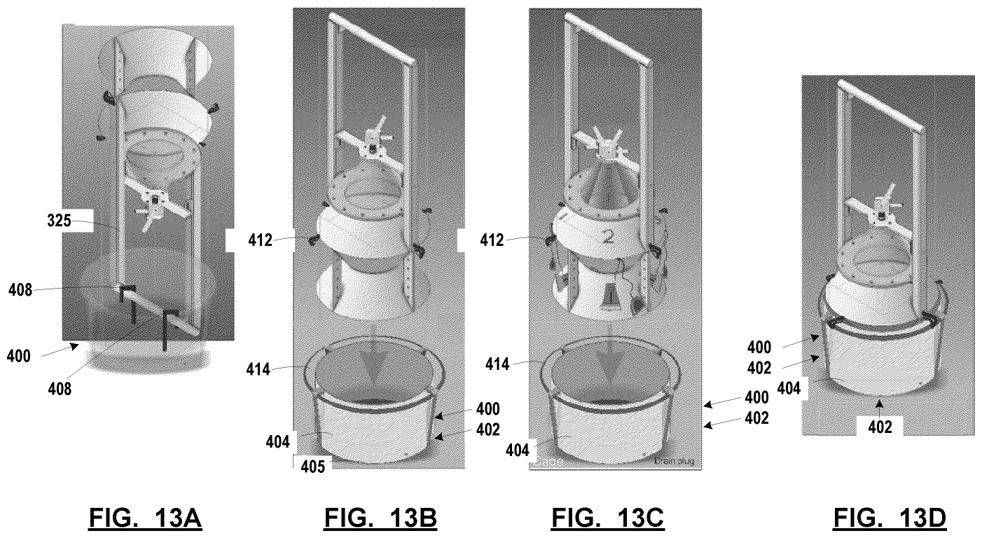

For example, as shown in FIG. 13A, confinement structure 400 may include one or more first retaining members 408 configured to retain a handle 325 of the collection vessel 300 (or 500) as the system 30 (or 50) descends into the subsea environment.

Generally, as shown in FIG. 13A, collection vessel 300 or 500 is inverted as it descends into a subsea environment.

Once collection vessel 300 (or 500) has collected a sample of gas, the collection vessel 300 (or 500) is positioned into the confinement structure 400. Collection vessel 300 is shown in FIG. 13B whereas collection vessel 500 is shown in FIG. 13C.

In one example, once collection vessel 300 (or 500) is positioned into the confinement structure 400, the collection vessel 300 (or 500) is secured to the confinement structure 400 by one or more second retaining members 412. In the embodiments shown in the drawings, the second retaining members are clips that are positioned on the body 302 of collection vessel 300 (or body 502 of collection vessel 500) and clip onto a ring 414 of the confinement structure. Although, it should be understood that other embodiments of retaining members 412 and ring 414 are possible.

While the above description provides examples of one or more apparatus, methods, or systems, it will be appreciated that other apparatus, methods, or systems may be within the scope of the claims as interpreted by one of skill in the art.

What is claimed is:

1. A system for collecting a sample of a gas in an aqueous environment, the system comprising:
a collection vessel comprising:
a body having:
an outer wall defining a cavity of the main body; and
a bottom edge forming a perimeter around an opening on an underside of the body, the cavity extending inwardly from the opening, the opening being sized to receive the sample of the gas into the cavity as the sample of the gas travels upwardly and the main body is positioned directly above the sample of gas in the aqueous environment; and
a valve coupled to the body, the valve being configured to provide for the sample of the gas to be removed from the cavity without the sample of the gas travelling through the opening on the underside of the main body; and
a confinement structure comprising:
a frame having at least one side wall, an opening on a top side of the frame and a cavity extending inwardly from the opening, the opening being sized to receive the collection vessel therein after the collection vessel has collected the sample of the gas; and
a coupling mechanism configured to retain the collection vessel at least partially in the cavity of the frame, the opening of the collection vessel remaining below the opening of the confinement structure when the collection vessel is received in the cavity of the confinement structure to retain the collection vessel in the confinement structure and provide for the sample of the gas to remain inside the cavity of the collection vessel.

2. The system of claim 1, wherein the collection vessel includes a first handle coupled to the main body and extending upwardly from the main body.

3. The system of claim 2, wherein the lid is further configured to provide for the first handle to extend outwardly from the confinement structure when the collection vessel is retained in the cavity of the confinement structure.

4. The system of claim 3, wherein the lid is shaped to define an opening therein to provide for the first handle to extend outwardly from the confinement structure when the collection vessel is retained in the cavity of the confinement structure.

5. The system of claim 3, wherein the lid is shaped to define an opening therein to provide for the valve to extend outwardly from the confinement structure when the collection vessel is retained in the cavity of the confinement structure.

6. The system of claim 1, wherein the lid is configured to move between a first position where it does not obstruct the opening of the confinement structure and a second position where it at least partially obstructs the opening of the confinement structure.

7. The system of claim 6, wherein the lid is configured to slide between the first position and the second position along an upper edge of the frame of the confinement structure.

8. The system of claim 1, wherein a height of the confinement structure is greater than a height of the body of the collection vessel.

9. The system of claim 1, wherein the collection vessel includes one or more vents in a lower portion thereof to provide for excess gas and water within the cavity of the collection vessel to move outwardly from the collection vessel through the vents and into the cavity of the confinement structure when collection vessel is positioned within the cavity of the confinement structure.

10. The system of claim 9, wherein a height of an uppermost portion of the one or more vents is less than a height of the sidewalls of the confinement structure.

11. The system of claim 1, wherein the collection vessel includes a second handle extending laterally outward from the body.

12. The system of claim 1, wherein the body has an upper component and a lower component, the lower component having a first portion coupled to a second portion, each of the upper component, the first portion of the lower component and the second portion of the lower component having respective cavities that are fluidly coupled to each other, the second portion having the bottom edge forming the perimeter around the opening.

13. The system of claim 12, wherein the first portion of the lower component is shaped to restrict movement of the sample of gas from the cavity of the upper component towards the opening.

14. The system of claim 13, wherein the first portion of the lower component has a truncated biconical shape.

15. The system of claim 12, wherein the second portion of the lower component has a conical shape.

16. The system of claim 12, wherein the body is configured to separately collect and separately retain more than one sample of the gas and/or more than one sample of more than one gas.

17. A method of collecting a sample of a gas from an aqueous environment, the method comprising:
positioning an opening of a collection vessel above the sample of the gas within the aqueous environment;
providing for the sample of gas to pass upwardly through the opening and into a cavity of the collection vessel;
placing the collection vessel inside a cavity of a confinement structure in an upright position, the cavity of the confinement structure having water retained therein;
securing the collection vessel at least partially within the cavity of the confinement structure; and
collecting the sample of the gas from the cavity of the collection vessel through a valve of the collection vessel.

18. The method of claim 17, wherein placing the collection vessel inside the cavity of a confinement structure in an upright position includes passing the collection vessel through the opening of the confinement structure while the collection vessel is in the upright position.

19. The method of claim 17, wherein securing the collection vessel at least partially within the cavity of the confinement structure inhibits the collection vessel from moving between the upright position and an inverted position, thereby retaining the sample of the gas in the cavity of the collection vessel below a water seal.

20. The method of claim 17, securing the collection vessel at least partially within the cavity of the confinement structure provides for a user to grasp a handle of the collection vessel and control movement of the collection vessel and the confinement structure.
